(19) United States
(12) Patent Application Publication
(10) Pub. No.: US 2009/0001899 A1
(43) Pub. Date: Jan. 1, 2009

(54) Fluorescent Lamp With Built-In Anion Generator

(75) Inventor: Don Saeng Lee, Bucheon (KR)

Correspondence Address: EDWARDS ANGELL PALMER & DODGE LLP, P.O. BOX 55874, BOSTON, MA, 02205, US

(73) Assignees: AD MAIN KOREA INC., Seoul (KR); AD MAIN INC., Tokyo (JP)

(21) Appl. No.: 12/278,669

(22) PCT Filed: Feb. 16, 2007
(86) PCT No.: PCT/KR2007/000836

§ 371 Date: Aug. 7, 2008

(30) Foreign Application Priority Data
Feb. 16, 2006 (KR) 10-2006-0015291
Sep. 8, 2006 (KR) 10-2006-0086947

(51) Int. Cl. H05B 41/295

(52) U.S. Cl. 315/200 R

(57) ABSTRACT

The invention is a a fluorescent lamp with built-in anion generator. The invention includes a bulb 22 with built-in filaments 21, said bulb being coated with a fluorescent material on its inner circumferential surface, said bulb having an inert gas sealed in its inside, and a base 24 integrally combined with said bulb 22, said base having terminal pins 26 projecting from the bottom so as to be fitted in terminal pin insertion holes 15 of a fluorescent lamp equipment 12, wherein an anion generator 30 is integrally built in the base 24 so as to be connected to an electric wire 28, said electric wire connecting a terminal pin 26 with the filament 21 of the bulb 22, anion emitting holes 31 are formed on the base 24 and thus the anion generator 30 is driven by drawing the electric current through the terminals of the fluorescent lamp 20.

### TECHNICAL FIELD

1. Field of the Invention

The present invention relates to a fluorescent lamp with built-in anion generator and more particularly to a fluorescent lamp with built-in anion generator, having a novel structure, which is simple in structure, low in cost and results in little environmental pollution and which can be applied to the type of fluorescent lamp without built-in stabilizer.

2. Background of the Invention

The anion generators are popularly installed indoors, on the ground that the anions are known to have health-favorable functions of promoting the metabolism, activating the cells, increasing the bacterial resistance, helping the sterilization and so on. In recent years, such products as fluorescent lamps having an anion generating function, instead of using separate anion generators, are being introduced on the market. A typical existing fluorescent lamp with built-in anion generator has the structure that a bulb 4 is mounted on a housing 2 of electric bulb type fluorescent lamp provided with a screw type base 3, wherein an anion generating portion 6 protrudes on the juncture between the bulb 4 and the housing 2 and an anion generating circuit 8 together with a balast circuit 7 is disposed in the housing 2, as shown in FIG. 1. The current of anion generating circuit 8 is drawn from the current applied on the base 3 of the lamp, as the anion generating circuit 8 and the balast circuit 7 are connected in parallel.

As described above, the conventional anion generator incorporating fluorescent lamp was the electric bulb type fluorescent lamp with a screw base 3 having the incorporated balast circuit 7 in the bulky housing 2. Further, as this kind of fluorescent lamp is added by the balast circuit 7, the structure is complicated and relatively costly and so makes it impossible to manufacture a lamp with anion generating function at a low cost. Furthermore, there is a problem of increased waste when life-elapsed lamps are dumped. Importantly, the conventional art has its limit in that the type of fluorescent lamp without built-in balast can not have the function of generating anions, because the conventional anion generator is able to be applied exclusively to the fluorescent lamp appliance with built-in balast circuit 7.

### SUMMARY OF THE INVENTION

The present invention was proposed to resolve the problems associated with the conventional fluorescent lamp with built-in anion generator, as described above. Thus, the object of the invention is to provide a fluorescent lamp with built-in anion generator, having a novel structure, which anion generator utilizes the electric current withdrawn from the lamp without built-in balast circuit 7, wherein the inventive lamp is simple in structure and circuit arrangement and so can be manufactured at a low cost and further leaves little waste due to its simple structure.

### BRIEF DESCRIPTION OF THE DRAWINGS

FIG. 1 shows the structure of a conventional lamp with built-in anion generator,

FIG. 2 shows the concept of the invention,

FIG. 3 shows the apparent view of an embodiment according to the invention,

FIG. 4 shows the circuit arrangement of the above embodiment, and

FIG. 5 shows the apparent view of another embodiment according to the invention.

FIG. 6 to 9 shows another embodiment of the invention.

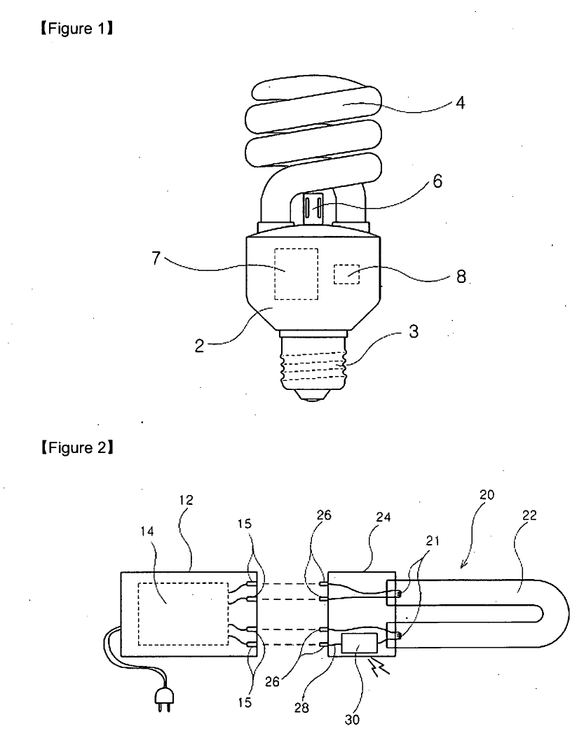

### DETAILED DESCRIPTION OF THE INVENTION

According to the invention, there is provided a fluorescent lamp with built-in anion generator, based on an external balast type fluorescent lamp 20 electrically connected to, in use, the fluorescent lamp equipment 12 with a balast circuit 14 and with a lamp socket in type of terminal pin insertion holes 15, said fluorescent lamp with built-in anion generator including a bulb 22 with built-in filaments 21, said bulb being coated with a fluorescent material on its inner circumferential surface, said bulb having an inert gas sealed in its inside, and a base 24 integrally combined with said bulb 22, said base having terminal pins 26 projecting from the bottom so as to be fitted in terminal pin insertion holes 15 of a fluorescent lamp equipment 12, wherein an anion generator 30 is integrally built in the base 24 so as to be connected to an electric wire 28, said electric wire connecting a terminal pin 26 with the filament 21 of the bulb 22, anion emitting holes 31 are formed on the base 24 and thus the anion generator 30 is driven by drawing the electric current through the terminals of the fluorescent lamp 20.

According to another feature of the invention, the anion generator 30 includes a rectifying section 32 for converting the alternate current from a balast circuit 14 of the fluorescent lamp equipment 12 into a direct current, a constant voltage section 34 for regulating the rectified power to a constant voltage level, an anion generating section 36 for generating anions, said anion generating section being connected to the constant voltage section 34, and a LED lamp section 38 disposed and exposed on the base 24 for indicating whether the anion generating section 36 is in operation.

According to a still other feature of the invention, a switch 27 is provided on the base 24 to selectively switch the connection between the anion generator 30 and a plurality of terminal pins 26.

According to a still other feature of the invention, there is provided a fluorescent lamp with built-in anion generator having straight tube type bulb 114 and a base 115 with a terminal pins 116 at the end of bulb 114, said bulb having an inert gas sealed in its inside, the fluorescent lamp further includes a housing 120 having the terminal pin insertion holes 124 on one end and the terminal pins 125 on the other end with the same dimension of said terminal pins 116, an anion generator 121 electrically connected between the contacts 127 within the insertion holes 124 and the terminal pin 125 inside the housing 120 and being driven by the current drawn from the current flowing into the terminal of the fluorescent lamp 10, the housing 120 having an anion emitting holes 126 on the surface of it.

According to a still other feature of the invention, the housing 120 is of cylindrical shape with the same diameter of the bulb 114, and the anion generator 121 includes a rectifying section 32 for converting AC from a balast circuit of the fluorescent lamp equipment into DC, a constant voltage section 34 for regulating the rectified power to a constant voltage level, an anion generating section 36 connected to the constant voltage section 134 for generating anion, and a LED lamp section exposed on the surface of the housing 120 for indicating whether the anion generating section is in operation.

The invention is described in detail below along preferred embodiments with reference to the accompanying drawings.

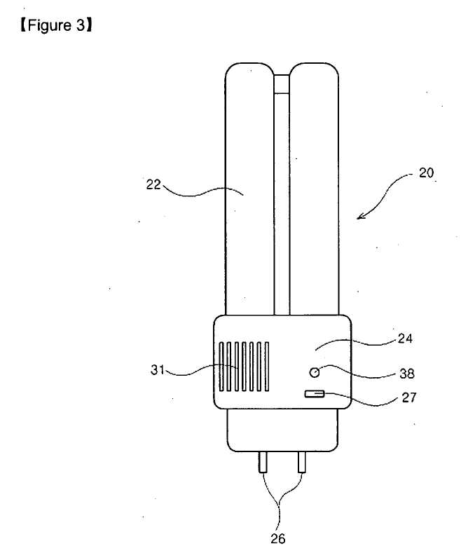

FIG. 2 shows a drawing illustrating the concept of a fluorescent lamp with built-in anion generator according to the invention, wherein a balast 14 is built in and terminal pin insertion holes 15 for combining with a fluorescent lamp 20 are formed on a fluorescent lamp equipment 12, in which a fluorescent lamp 20 according to the invention is fitted for service. This fluorescent lamp 20 includes a bulb 22 with built-in filaments 21 and a base 24 integrally formed with the bulb 22, wherein the base 24 is formed with 4 protruding terminal pins 26 in the figure. The terminal pins 26 are to be fitted in terminal pin insertion holes 15 of the fluorescent lamp equipment 12.

The anion generator 30 is provided in the base 24, wherein the anion generator 30 is connected to one electric line 28 of the 4 lines, which lines serve to connect the filaments 21 with terminal pins 26. Accordingly, the inventive anion generator 30 uses the electric current by drawing it from the fluorescent lamp 20 through where it flows. The use of the electric current by drawing it from a fluorescent lamp 20 little affects the luminosity of the lamp 20, because the anion generator 30 consumes the electric current of low power, for example, less than 0.5 to 1 watt.

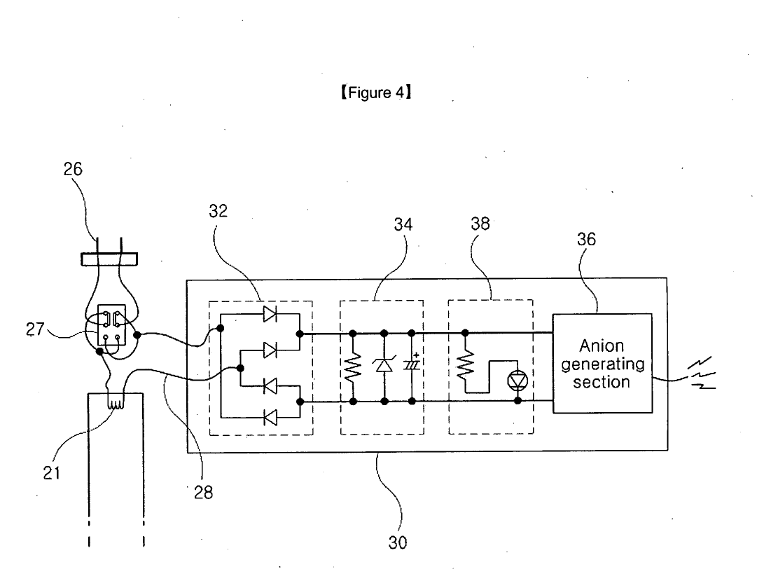

FIG. 3 shows the external view of an embodiment of the invention and FIG. 4 shows the circuit diagram of the afore-mentioned embodiment. The embodiment shown corresponds to a so-called four pin type fluorescent lamp, in which a base 24 is disposed on one side of a bulb 22 and 4 terminal pins 26 are provided on one side of the base 24. Anion emitting holes 31 are formed on the outer circumferential surface of the base 24. Inside the base 24, an anion generator 30 is connected onto an electric line 28 which connects a terminal pin 26 on one side and filament 21.

This anion generator 30 includes a rectifying section 32 for converting the alternate current from a balast circuit 14 of the fluorescent lamp equipment 12 into a direct current, a constant voltage section 34 for regulating the rectified power to a constant voltage level and an anion generating section 36, which receives the constant voltage DC from the constant voltage section 34 and discharges to a high voltage so that anions may be generated. Further, an LED lamp section 38 is connected between the constant voltage section 34 and the anion generating section 36 to indicate whether the anion generating section 36 is in operation.

On the other hand, for an fluorescent lamp circuit, during the initial lighting time, starting current flows through the terminals to which the starter or condenser is connected, and then ceases to flow to cut off the electricity. Therefore, care should be taken so that the anion generator 30 is not connected to a terminal on the side of the starter or condenser where the electric current is cut off as described above. Accordingly, even if, in manufacturing anion generators 30 according to the invention, a worker connects the anion generator 30 to any of electric lines 28 which connects the terminal pin 16 and the filament 21, correct connection with the balast circuit 14 needs to be made when insertion in fluorescent lamp equipment 12 is conducted. This role is assumed by a switch 27.

The circuit of the anion generator 30 can be properly selected depending on the mode of the balast. Although a separate modularized anion generating section 36 for DC is used in the embodiment as shown, for the electronic type exclusive balast, transformer and double-voltage rectifying circuit may be used to build the anion generating circuit.

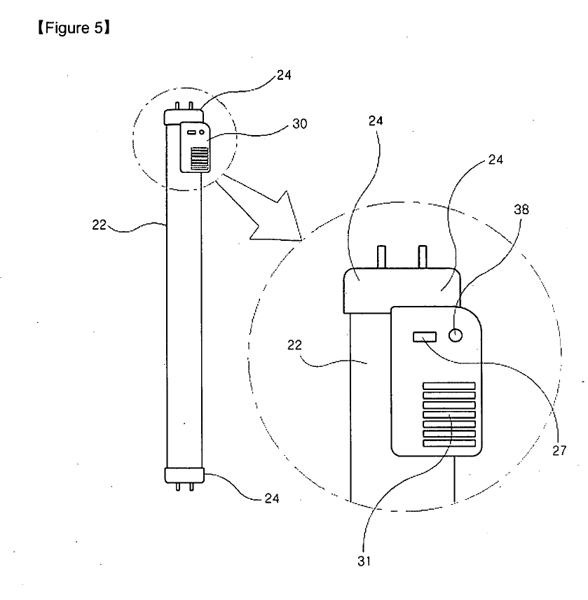

FIG. 5 shows another embodiment of the invention, wherein an ordinary straight tube fluorescent lamp is integrally provided with an anion generator 30 on one of the both end bases 24. In this case, in order to use existing commercial straight tube bulbs 22 as they are, an anion generator 30 is provided on the outer circumference of one end of the bulb 22, through extended use of base 24, while the original total length of the lamp bulb is not changed, as seen in the figure. This embodiment is the same as the first one in the point that the anion generator 30 is driven by drawing lamp driving current output from the external balast.

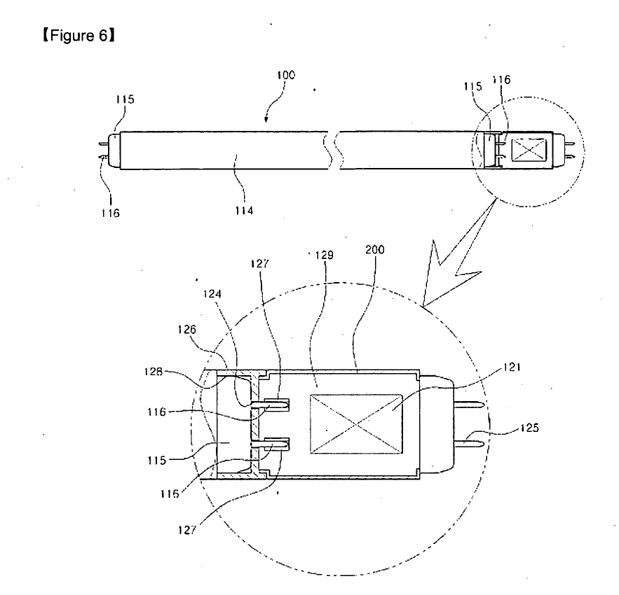

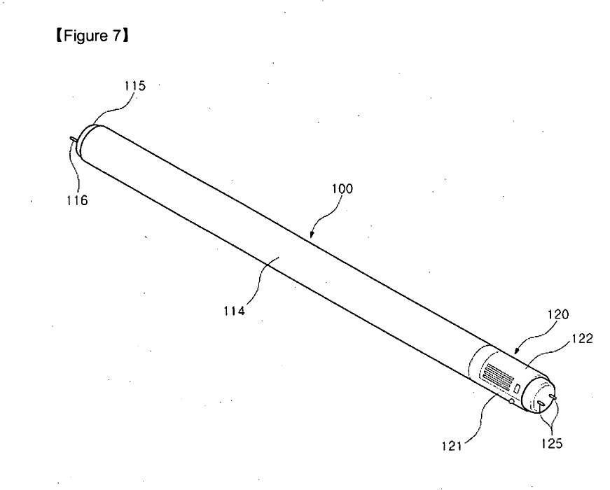

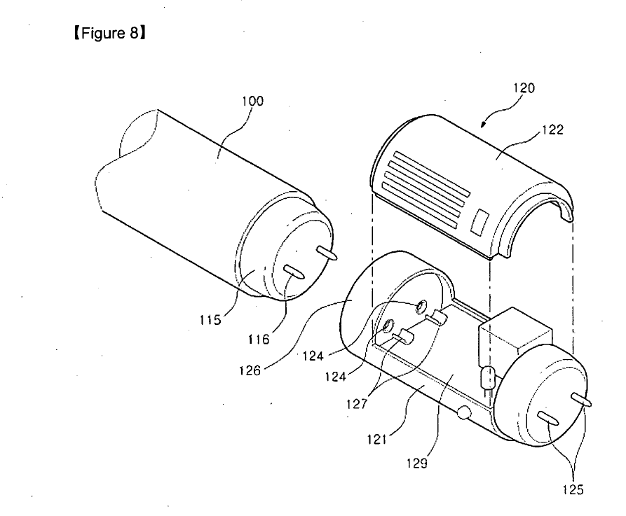

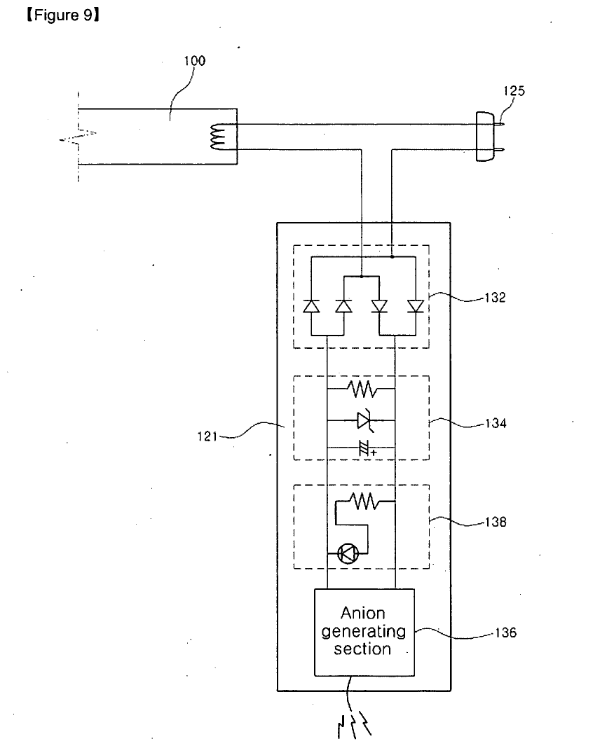

FIG. 6 to 9 show still another embodiment of the invention, wherein a straight tube fluorescent lamp is integrally provided with an anion generator on one of the both end base. In this case, the length of bulb 114 of the straight tube is shorter than the ordinary bulb of the straight tube. The cylindrical housing 120 of the anion generator 121 has the terminal pin insertion holes 124 on one end and the terminal pins 125 on the other end with the same dimension of the terminal pins 116. The anion generator 121 inside the housing 120 is electrically connected between the contacts 127 within the insertion holes 124 and the terminal pin 125.

The housing 120 includes semi-cylindrical body 121 and cover 122. A coupling ring 126 is provided on one side of the body 121, the coulping ring 126 having the recess 128 into which the base 115 of the fluorescent lamp is inserted. The printed circuit board 129 of the anion generator is disposed in the body 121. The contacts 127 is provided on the printed circuit board 129 adjacent to the insertion holes 124 so as to electrically connect the inserted terminal pin 116 of the fluorescent lamp 100 with the printed circuit board 129.

The anion generator 121 of the embodiment also have the circuit similar to those of the above mentioned embodiments such as a rectifying section 132, a constant voltage section 134, an anion generating section 136 and a LED lamp section 138. But this embodiment does not have the switch 27 of the above mentioned embodiment. Therefore, if the user inserts terminal pins 125 of the anion generator 121 into the socket of the fluorescent lamp equipment in such a way that the anion generator 121 is connected with the starter or condenser of the balast circuit of the fluorescent lamp equipment, so the anion generator 121 is not operating, then the user can change the inserting direction and the anion generator will operate normally.

According to the present invention as described, the anion generator 30 can be driven by drawing the lamp driving current output from the external balast circuit 14 by connecting an anion generator 30 on the wire connecting the terminal pin 26 and the filament 21 of bulb 22 in the base 24, starting from a type of fluorescent lamp without incorporating a balast. Therefore, the type of fluorescent lamps without incorporating a balast can also provided with anion generating function, so that the width of choice for consumers can be further widened. In addition, application to the fluorescent lamps 20 without balast circuits 14 is possible, so that the structure and circuitry of the product are simplified and the cost is reduced. The switch 27 for selectively switching terminal pins 14 is provided, so that the normal current can be output from the balast circuit 14, no matter to which terminal in the base 24 the anion generator 30 is connected. Therefore, paying attention to the circuit connection is not necessary at the manufacturing step, which results in easy fabrication, increased productivity and decrease in failed products.

And, according to the present invention, a fluorescent lamp with built-in anion generator 121 1 can be provided without changing the dimension or appearance of the conventional straight tube type lamp, by disposing it between one end of the straight tube type fluorescent lamp and the socket of the fluorescent lamp equipment with the housing having the same diameter of the lamp tube. In addition, as the anion generator is inserted to the fluorescent lamp detacheably, if the life time of the fluorescent lamp ends, then the anion generator will be detached to be coupled with a new fluorescent lamp, which will result in cost savings.

1. A fluorescent lamp with built-in anion generator, based on an external balast type fluorescent lamp 20 electrically connected to, in use, the fluorescent lamp equipment 12 with a balast circuit 14 and with a lamp socket in type of terminal pin insertion holes 15, said fluorescent lamp with built-in anion generator including a bulb 22 with built-in filaments 21, said bulb being coated with a fluorescent material on its inner circumferential surface, said bulb having an inert gas sealed in its inside, and a base 24 integrally combined with said bulb 22, said base having terminal pins 26 projecting from the bottom so as to be fitted in terminal pin insertion holes 15 of a fluorescent lamp equipment 12, wherein an anion generator 30 is integrally built in the base 24 so as to be connected to an electric wire 28, said electric wire connecting a terminal pin 26 with the filament 21 of the bulb 22, anion emitting holes 31 are formed on the base 24 and thus the anion generator 30 is driven by drawing the electric current through the terminals of the fluorescent lamp 20.

2. A fluorescent lamp with built-in anion generator of claim 1, wherein the anion generator 30 includes a rectifying section 32 for converting the alternate current from a balast circuit 14 of the fluorescent lamp equipment 12 into a direct current, a constant voltage section 34 for regulating the rectified power to a constant voltage level, an anion generating section 36 for generating anions, said anion generating section being connected to the constant voltage section 34, and a LED lamp section 38 disposed and exposed on the base 24 for indicating whether the anion generating section 36 is in operation.

3. A fluorescent lamp with built-in anion generator of claim 1 or 2, wherein a switch 27 is provided on the base 24 to selectively switch the connection between the anion generator 30 and a plurality of terminal pins 26.

4. A fluorescent lamp with built-in anion generator having straight tube type bulb 114 and a base 115 with a terminal pins 116 at the end of bulb 114, said bulb having an inert gas sealed in its inside, the fluorescent lamp further includes a housing 120 having the terminal pin insertion holes 124 on one end and the terminal pins 125 on the other end with the same dimension of said terminal pins 116, an anion generator 121 electrically connected between the contacts 127 within the insertion holes 124 and the terminal pin 125 inside the housing 120 and being driven by the current drawn from the current flowing into the terminal of the fluorescent lamp 10, the housing 120 having an anion emitting holes 126 on the surface of it.

5. A fluorescent lamp with built-in anion generator of claim 4, wherein the housing 120 is of cylindrical shape with the same diameter of the bulb 114, and the anion generator 121 includes a rectifying section 32 for converting AC from a balast circuit of the fluorescent lamp equipment into DC, a constant voltage section 34 for regulating the rectified power to a constant voltage level, an anion generating section 36 connected to the constant voltage section 134 for generating anion, and a LED lamp section exposed on the surface of the housing 120 for indicating whether the anion generating section is in operation.
